(19) United States
(12) Patent Application Publication
(10) Pub. No.: US 2003/0004728 A1
(43) Pub. Date: Jan. 2, 2003

(54) System

(76) Inventor: Robert Alexander Keiller, Guildford (GB)

Correspondence Address: FITZPATRICK CELLA HARPER & SCINTO, 30 ROCKEFELLER PLAZA, NEW YORK, NY, 10112, US

(21) Appl. No.: 09/891,399

(22) Filed: Jun. 27, 2001

(51) Int. Cl. G10L 21/00; G10L 11/00

(52) U.S. Cl. 704/275

(57) ABSTRACT

A processor-controlled machine (3a) is coupled via a control apparatus (34) to speech processing apparatus (2) for enabling a user to control at least one function of the machine by spoken commands. The speech processing apparatus (2) has a speech recognition engine (201) associated with a grammar module (202) for providing the speech recognition grammar or grammars required by the engine (201). The control apparatus (34) provides the speech processing apparatus (2) with instructions regarding the speech recognition grammars to be used for recognising speech data. The grammar store stores at least first and second grammars having grammar rules and at least one interface grammar defining grammar rules with the first grammar being arranged to use grammar rules defined by the interface grammar, and the second, being arranged to implement rules defined by the interface grammar so as to enable an extended grammar to be formed when the control apparatus provides instructions for causing the second grammar to be linked to the first grammar using the interface grammar.

This invention relates to a system, in particular to a system that enables voice control of devices or machines using an automatic speech recognition engine accessible by the devices, for example accessible over a network.

In conventional network systems, such as office equipment network systems, instructions for controlling the operation of a machine or device connected to the network are generally input manually, for example using a control panel of the device. Voice control of machines or devices may, at least in some circumstances, be more acceptable or convenient for a user. It is, however, not cost effective to provide each different machine or device with its own automatic speech recognition engine.

One solution to this problem is to provide a speech processing apparatus coupled to the network and to transmit the speech data over the network to the speech processing apparatus which, in response, provides instructions for enabling a machine coupled to the network to carry out a function specified by the spoken commands represented by the speech data. It is, of course, not practical for such speech processing apparatus to incorporate an automatic speech recognition engine trained for every possible user's voice. Rather, it is desirable to provide a single untrained automatic speech recognition engine. Although such a speech recognition engine could use a single grammar that contains the terms and phrases that may be used for voice control of any machines that may be coupled to the network, the use of such a single general grammar with an untrained automatic speech recognition engine may result in a high proportion of mis-recognitions and, moreover, may result in the speech processing operation being unacceptably slow.

It is an aim of the present invention to provide a system, a speech processing apparatus, a control apparatus and a grammar for use in such a system that enables voice control of machines using a remote speech processing apparatus using a speech recognition grammar that is adapted to the machine or machines to be controlled while providing a relatively simple and natural voice control interface for the user. For example, it is an aim of the present invention to enable a user to issue voice commands to enable, for example, a picture stored by a digital camera to be printed by a printer coupled to a network without the user having to separate camera-related speech commands from printer related speech commands and without the camera having to know about the printer commands available on the printer and without the printer having to know about the possible camera formatting commands.

In one aspect, the present invention provides a system comprising a processor-controlled machine for carrying out at least one function specified by a user and being couplable to a remote speech processing apparatus arranged to receive and interpret spoken commands issued by the user and to supply to control apparatus instructions or commands for enabling the or a different machine to carry out the function required by the user, wherein the speech processing apparatus has access to at least first and second grammars having grammar rules and at least one interface grammar defining grammar rules such that the first grammar is arranged to use grammar rules defined by the interface grammar and the second grammar is arranged to implement rules defined by the interface grammar and wherein the control apparatus is arranged to provide instructions for causing the second grammar to be linked to the first grammar using the interface grammar to produce an extended grammar when the control apparatus determines that the use of an extended grammar is necessary.

In an embodiment the processor-controlled machine to which the user directs the spoken commands is a digital camera while the processor-controlled machine carrying out the at least one function is a printer and the digital camera includes a control apparatus arranged to provide instructions for causing the first and second grammars to be linked using the interface grammar when a user's spoken instructions indicate that an image stored by the digital camera is to be printed. This arrangement means that the digital camera does not need to have any information about the functionality of any of the printers that may be used to print its images. Similarly, the available printers do not need to have any information about the digital camera. This enables the printer and digital camera to be manufactured and supplied completely independently from one another and should mean that, for example, a network operator does not need to ensure compatibility, at least from the point of view of speech control, between machines coupled to a network.

The present invention may also enable, for example, a generic grammar for a particular type of machine, (printer, photocopier, facsimile machine etc) to be provided which can be linked via an interface grammar to a second grammar specific to the particular machine. This would mean that, for example, a generic printer grammar could be provided and that individual printer manufacturers would only need to provide grammars specific to the particular non-generic features and functions provided by their printers and would also facilitate upgrading or changing of the specific printing grammars because it would not be necessary to change the entire printer grammar, only the grammar specific to that specific printer.

The present invention also provides a speech processing apparatus having, or having means for accessing, a speech recognition grammar store comprising at least first and second grammars having grammar rules and at least one interface grammar defining grammar rules, with the first grammar being arranged to use grammar rules defined by the interface grammar and the second grammar being arranged to implement rules defined by the interface grammar such that the first and second grammars can be linked using the interface grammar to form an extended grammar.

The present invention also provides a control apparatus for coupling a processor-controlled machine to speech processing apparatus for enabling a user to control a function of a machine by spoken command, wherein the control apparatus is arranged to provide to the speech processing apparatus speech data and speech recognition grammar instructions including, where appropriate, instructions for causing first and second grammars to be linked by an interface grammar having grammar rules usable by the first grammar and implementable by the second grammar to form an extended grammar.

The present invention also provides a grammar store for use in or by a system or speech processing apparatus as set out above wherein the grammar store has at least first and second grammars and at least one interface grammar defining grammar rules usable by the first grammar and implementable by the second grammar to enable first and second grammars to be linked by an interface grammar to form an extended grammar.

More than one interface grammar may be provided and, for example, it may be possible to link the second grammar to a further grammar by a further interface grammar defining grammar rules usable by the second grammar and implementable by the further grammar so as to link the three grammars together. This interface linking may be further expanded so as to enable a cascade of grammars to be connected together via interface grammars in accordance with instructions received from the processor-controlled machine or control apparatus to which the user's voice commands are directed.

Preferably, the control apparatus comprises a JAVA virtual machine.

The processor-controlled machine may be, for example, an item of office equipment such as a photocopier, printer, facsimile machine or multi-function machine capable of facsimile, photocopy and printing functions and/or may be an item of home equipment such as a domestic appliance such as a television, a video cassette recorder, a microwave oven and so on.

Embodiments of the present invention will now be described, by way of example, with reference to the accompanying drawings, in which:

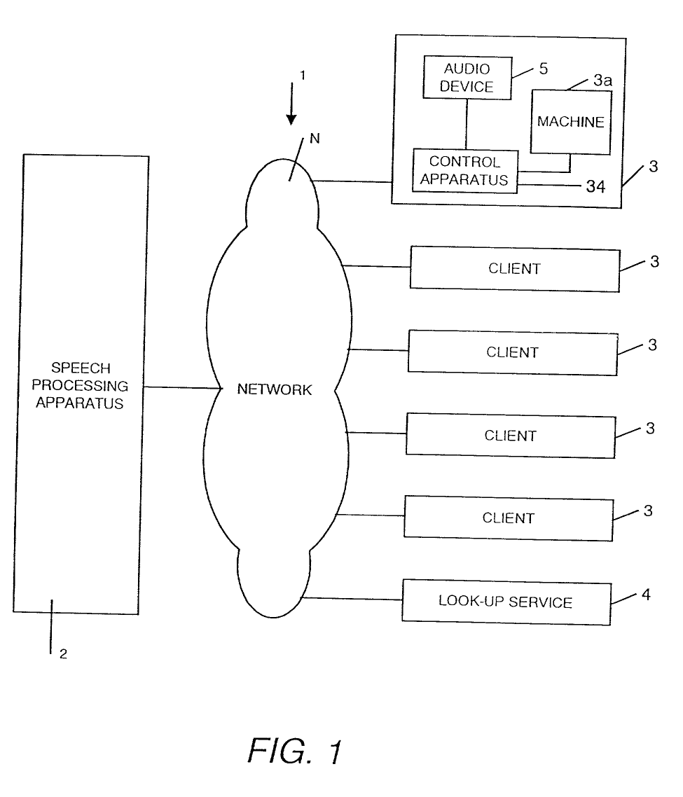

FIG. 1 shows a schematic block diagram of a system embodying the present invention;

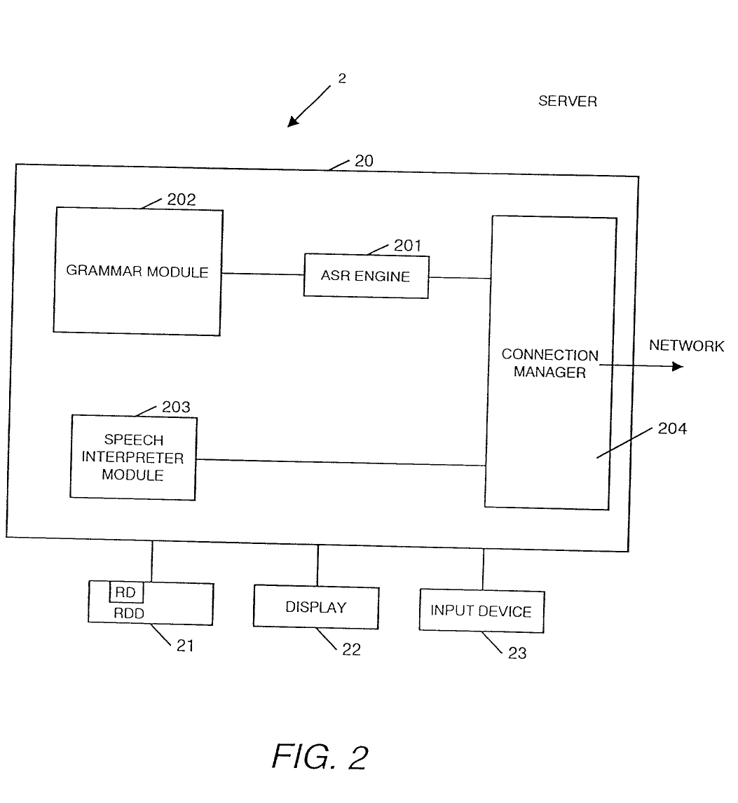

FIG. 2 shows a schematic block diagram of a speech processing apparatus of the system shown in FIG. 1;

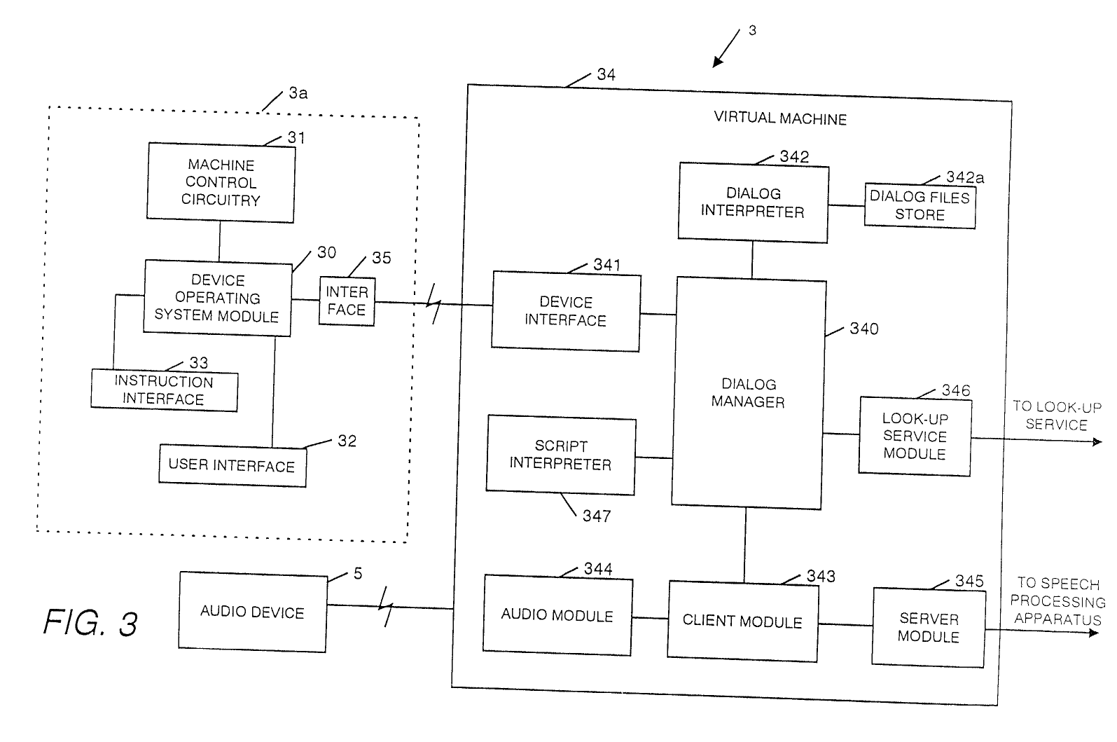

FIG. 3 shows a schematic block diagram to illustrate a processor-controlled machine and its connection to a control apparatus and audio device;

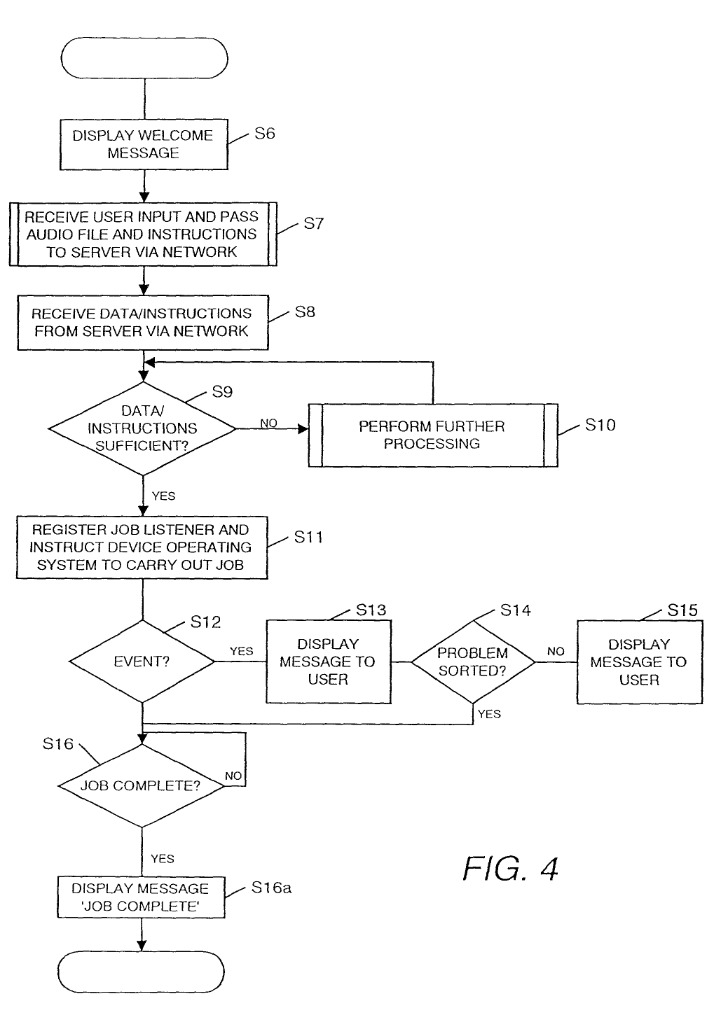

FIG. 4 shows a flow chart for illustrating steps carried out by a virtual machine of a client when a user instructs the client to carry out a job or function;

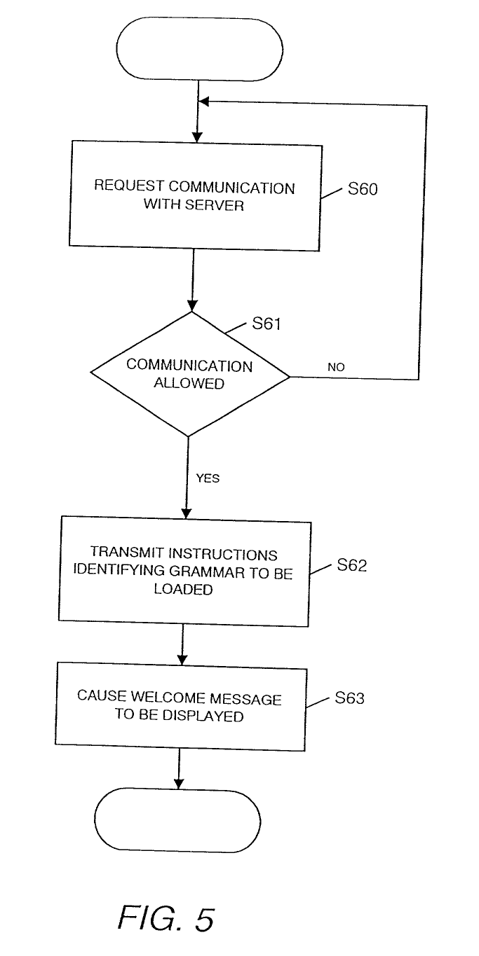

FIG. 5 shows a flow chart illustrating in greater detail a step shown in FIG. 4;

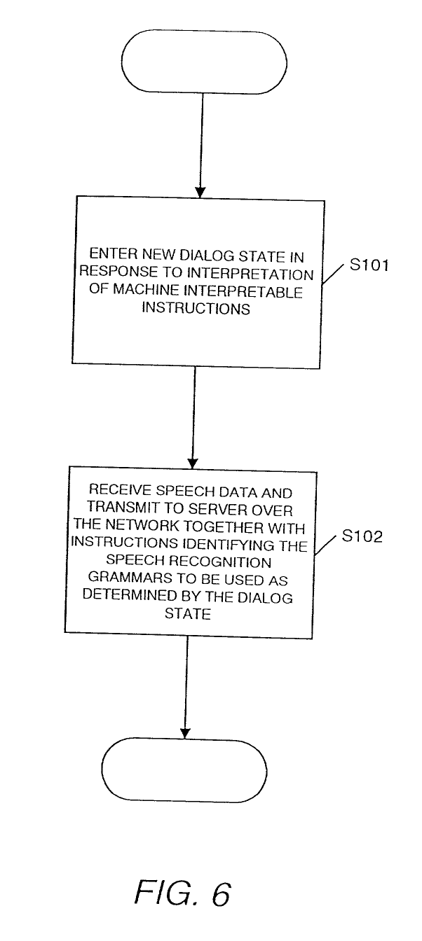

FIG. 6 shows a flow chart illustrating in greater detail a step shown in FIG. 4;

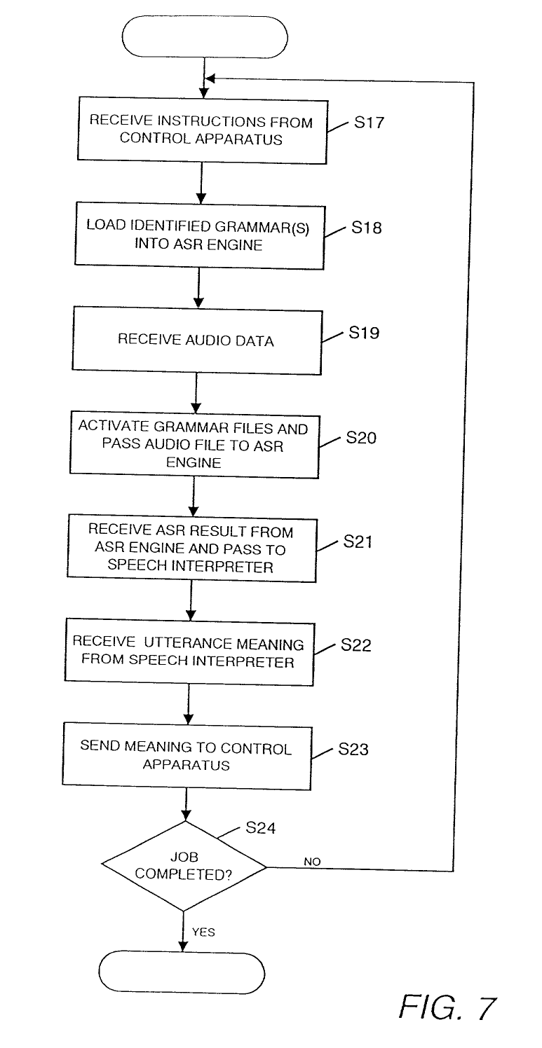

FIG. 7 shows a flow chart illustrating steps carried out by speech processing apparatus shown in FIG. 1 to enable a voice-controlled job to be carried out by a client of the system shown in FIG. 1;

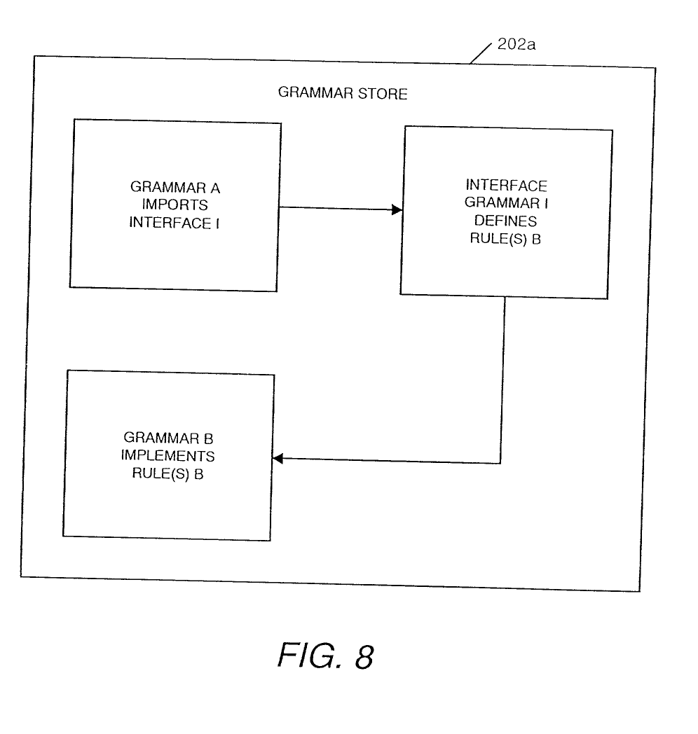

FIG. 8 shows a functional block diagram of a grammar store to illustrate the linking of grammars;

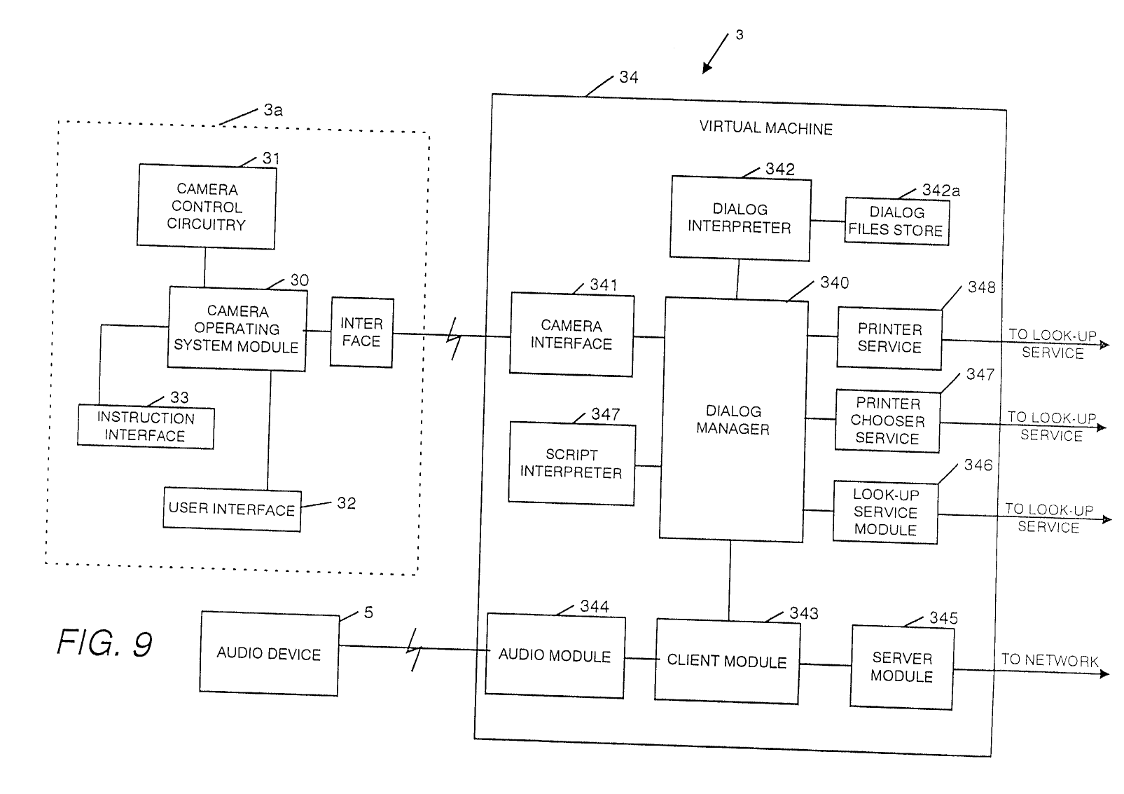

FIG. 9 shows a schematic block diagram of a client which comprises as the processor-controlled machine a digital camera;

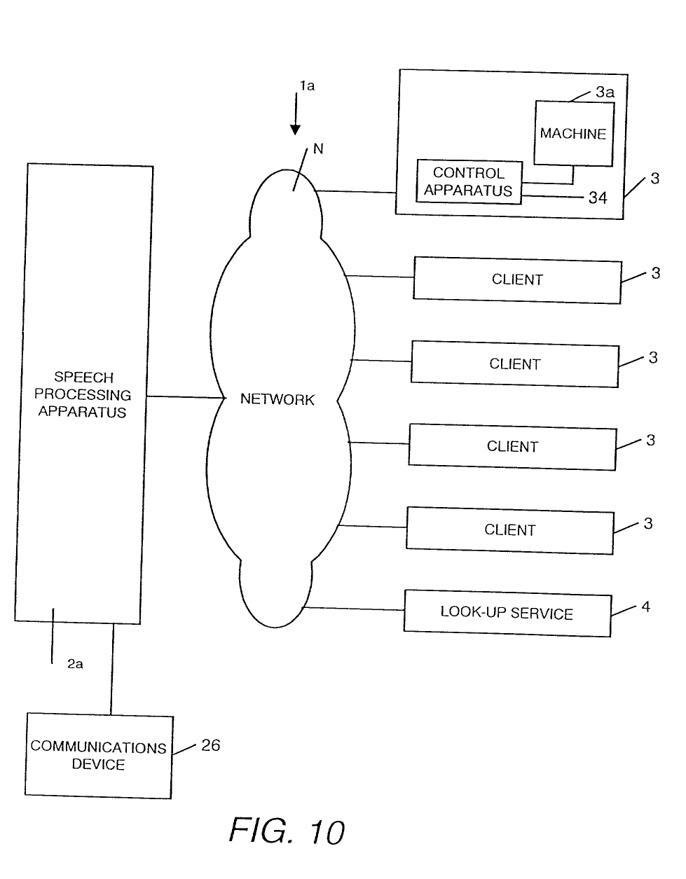

FIG. 10 shows a schematic block diagram similar to FIG. 1 of another system embodying the invention;

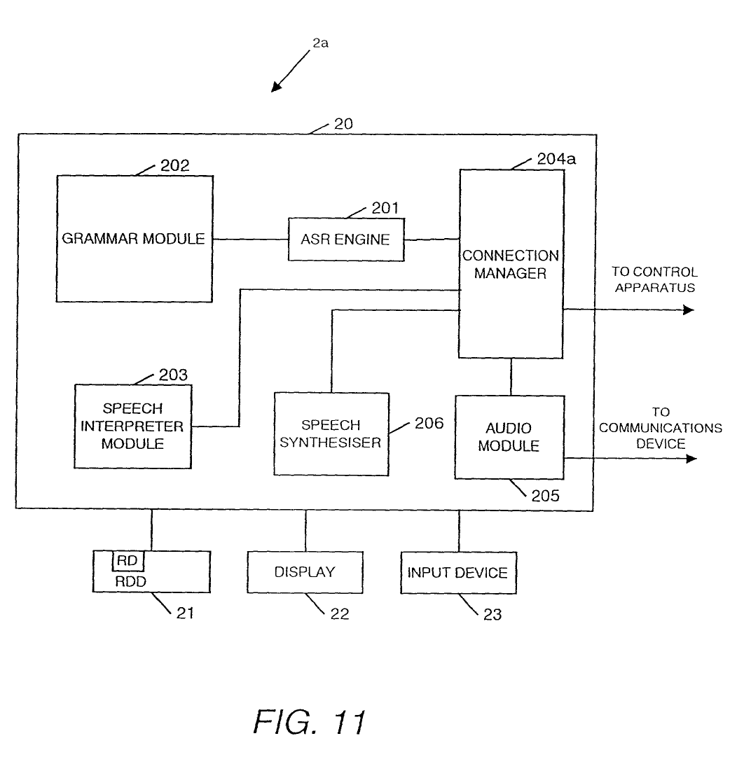

FIG. 11 shows a schematic block diagram similar to FIG. 2 of a modified form of speech processing apparatus for use in the system shown in FIG. 10; and

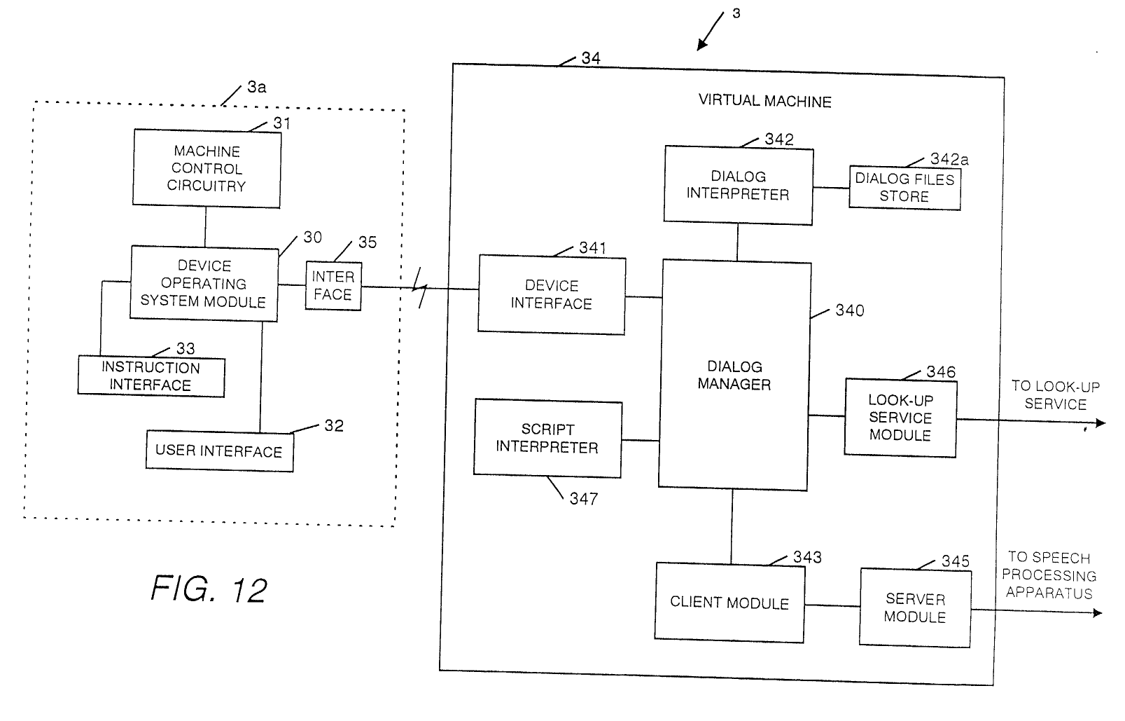

FIG. 12 shows a block schematic diagram similar to FIG. 3 of a client suitable for use in the system shown in FIG. 10.

FIG. 1 shows by way of a block diagram a system 1 comprising a speech processing apparatus or server 2 coupled to a number of clients 3 and to a look-up service 4 via a network N. As shown for one client in FIG. 1, each client 3 comprises a processor-controlled machine 3a, an audio device 5 and a control apparatus 34. The control apparatus 34 couples the processor-controlled machine 3a to the network N.

The machines are in the form of items of electrical equipment found in the office and/or home environment and capable of being adapted for communication and/or control over a network N. Examples of items of office equipment are, for example, photocopiers, printers, facsimile machines, digital cameras and multi-functional machines capable of copying, printing and facsimile functions while examples of items of home equipment are video cassette recorders, televisions, microwave ovens, digital cameras, lighting and heating systems and so on.

The clients 3 may all be located in the same building or may be located in different buildings. The network N may be a local area Network (LAN), wide area network (WAN), an Intranet or the Internet. It will, of course, be understood that, as used herein the word “network” does not necessarily imply the use of any known or standard networking system or protocol and that the network N may be any arrangement that enables communication with items of equipment or machines located in different parts of the same building or in different buildings.

The speech processing apparatus 2 comprises a computer system such as a workstation or the like. FIG. 2 shows a functional block diagram of the speech processing apparatus 2. The speech processing apparatus 2 has a main processor unit 20 which, as is known in the art, includes a processor arrangement (CPU) and memory such as RAM, ROM and generally also a hard disk drive. The speech processing apparatus 2 also has, as shown, a removable disk drive RDD 21 for receiving a removable storage medium RD such as, for example, a CDROM or floppy disk, a display 22 and an input device 23 such as, for example, a keyboard and/or a pointing device such as a mouse.

Program instructions for controlling operation of the CPU and data are supplied to the main processor unit 20 in at least one of two ways:

1) as a signal over the network N; and

2) carried by a removable data storage medium RD. Program instructions and data will be stored on the hard disk drive of the main processor unit 20 in known manner.

FIG. 2 illustrates block schematically the main functional components of the main processor unit 20 of the speech processing apparatus 2 when programmed by the aforementioned program instructions. Thus, the main processor unit 20 is programmed so as to provide: an automatic speech recognition (ASR) engine 201 for recognising speech data input to the speech processing apparatus 2 over the network N from the control apparatus 34 of any of the clients 3; a grammar module 202 for storing grammars defining the rules that spoken commands must comply with and words that may be used in spoken commands; and a speech interpreter module 203 for interpreting speech data recognised using the ASR engine 201 to provide instructions that can be interpreted by the control apparatus 34 to cause the associated processor-controlled machine 3a to carry out the function required by the user. The main processor unit 20 also includes a connection manager 204 for controlling overall operation of the main processor unit 20 and communicating via the network N with the control apparatus 34 so as to receive audio data and to supply instructions that can be interpreted by the control apparatus 34.

As will be appreciated by those skilled in the art, any known form of automatic speech recognition engine 201 may be used. Examples are the speech recognition engines produced by Nuance, Lernout and Hauspie, by IBM under the Trade Name “ViaVoice” and by Dragon Systems Inc. under the Trade Name “Dragon Naturally Speaking”. As will be understood by those skilled in the art, communication with the automatic speech recognition engine is via a standard software interface known as “SAPI” (speech application programmers interface) to ensure compatibility with the remainder of the system. In this case, the Microsoft SAPI is used. The grammars stored in the grammar module may initially be in the SAPI grammar format. Alternatively, the server 2 may include a grammar pre-processor for converting grammars in a non-standard form to the SAPI grammar format.

FIG. 3 shows a block schematic diagram of a client 3. The processor-controlled machine 3a comprises a device operating system module 30 that generally includes CPU and memory (such as ROM and/or RAM). The operating system module 30 communicates with machine control circuitry 31 that, under the control of the operating system module 30, causes the functions required by the user to be carried out. The device operating system module 30 also communicates, via an appropriate interface 35, with the control apparatus 34. The machine control circuitry 31 will correspond to that of a conventional machine of the same type capable of carrying out the same function or functions (for example photocopying functions in the case of a photocopier) and so will not be described in any greater detail herein.

The device operating system module 30 also communicates with a user interface 32 that, in this example, includes a display for displaying messages and/or information to a user and a control panel for enabling manual input of instructions by the user.

The device operating system module 30 may also communicate with an instruction interface 33 that, for example, may include a removable disk drive and/or a network connection for enabling program instructions and/or data to be supplied to the device operating system module 30 either initially or as an update of the original program instructions and/or data.

In this embodiment, the control apparatus 34 of a client 3 is a JAVA virtual machine 34. The JAVA virtual machine 34 comprises processor capability and memory (RAM and/or ROM and possibly also hard disk capacity) storing program instructions and data for configuring the virtual machine 34 to have the functional elements shown in FIG. 3. The program instructions and data may be pre-stored in the memory or may be supplied as a signal over the network N or may be provided on a removable storage medium receivable in a removable disc drive associated with the JAVA virtual machine or, indeed, supplied via the network N from a removable storage medium in the removable disc disc drive 21 of the speech processing apparatus.

The functional elements of the JAVA virtual machine include a dialog manager 340 which co-ordinates the operation of the other functional elements of the JAVA virtual machine 34.

The dialog manager 340 communicates with the device operating system module 30 via the interface 35 and a device interface 341 of the control apparatus that enables instructions to be sent to the machine 3a and details of device and job events to be received. In order to enable an operation or job to be carried out under voice control by a user, as will be described in greater detail below, the dialog manager 340 communicates with a script interpreter 347 and with a dialog interpreter 342 which uses a dialog file or files from a dialog file store 342 to enable a dialog to be conducted with the user via the device interface 341 and the user interface 32 in response to dialog interpretable instructions received from the speech processing apparatus 2 over the network N.

In this example, dialog files are implemented in VoiceXML which is based on the World Wide Web Consortiums Industry Standard Extensible Markup Language (XML) and which provides a high-level programming interface to speech and telephony resources. VoiceXML is promoted by the VoiceXML Forum found by AT&T, IBM Lucent Technologies and Motorola and the specification for version 1.0 of VoiceXML can be found at http://www.voicexml.org. Other voice-adapted mark-up languages may be used such as, for example, VoxML which is Motorola's XML based language for specifying spoken dialog. There are many text books available concerning XML, see for example “XML Unleashed” published by SAMS Publishing (ISBN 0-672-31514-9) which includes a chapter 20 on XML scripting languages and a chapter 40 on VoxML.

In this example, the script interpreter 347 is an ECMAScript interpreter (where ECMA stands for European Computer Manufacturer's Association and ECMAScript is a non-proprietary standardised version of Netscape's JAVAScript and Microsoft's JScript). A CD-ROM and printed copies of the current ECMA-290 ECMAScript Components Specification can be obtained from ECMA 114 Rue du Rhone CH-1204 Geneva Switzerland. A free interpreter for ECMAScript is available from http://home.worldcom.ch/jmlugrin/fesi. As another possibility the dialog manager 340 may be run as an applet inside a web browser such as Internet Explorer 5 enabling use of the browser's own ECMAScript Interpreter.

The dialog manager 340 also communicates with a client module 343 which communicates with the dialog manager 340, with an audio module 344 coupled to the audio device 5 and with a server module 345.

The audio device 5 may be a microphone provided as an integral component or add on to the machine 3a or may be a separately provided audio input system. For example, the audio device 5 may represent a connection to a separate telephone system such as a DECT telephone system or may simply consist of a separate microphone input. The audio module 344 for handling the audio input uses, in this example, the JavaSound 0.9 audio control system.

The server module 345 handles the protocols for sending messages between the client 3 and the speech processing apparatus or server 2 over the network N thus separating the communication protocols from the main client code of the virtual machine 34 so that the network protocol can be changed by the speech processing apparatus 2 without the need to change the remainder of the JAVA virtual machine 34.

The client module 343 provides, via the server module 345, communication with the speech processing apparatus 2 over the network N, enabling requests from the client 3 and audio data to be transmitted to the speech processing apparatus 2 over the network N and enabling communications and dialog interpretable instructions provided by the speech processing apparatus 2 to be communicated to the dialog manager 340. The dialog manager 340 also communicates over the network N via a look-up service module 346 that enables dialogs run by the virtual machine 34 to locate services provided on the network N using the look-up service 4 shown in FIG. 1. In this example, the look-up service is a JINI service and the look-up service module 346 provides a class which stores registrars so that JINI enabled services available on the network N can be discovered quickly.

As will be seen from the above, the dialog manager 340 forms the central part of the virtual machine 34. Thus, the dialog manager 340: receives input and output requests from the dialog interpreter 342; passes output requests to the client module 343; receives recognition results (dialog interpretable instructions) from the client module 343; and interfaces to the machine 3a, via the device interface 341, both sending instructions to the machine 3a and receiving event data from the machine 3a. As will be seen, audio communication is handled via the client module 343 and is thus separated from the dialog manager 340. This has the advantage that dialog communication with the device operating system module 30 can be carried out without having to use spoken commands, if the network connection fails or is unavailable.

The device interface 341 stores as a device object the information necessary for the JAVA virtual machine to determine the functions that can be carried out by the processor-controlled machine 3a and also enables registration in the dialog manager 340 of a device listener which receives notifications of events set by the machine control circuitry 31 such as, for example, when the machine 3a runs out of paper or toner in the case of a multi-function device or photocopier or when an event has occurred at the machine 3a which would affect the performance of a job, for example whether or not a document is present in a hopper in the case of a multifunctional device or photocopier.

In addition the device interface enables implementation by the JAVA virtual machine of any number of device specific methods including public methods which return Devicejob which is a wrapper around job such as printing or sending a fax which provides the client module 343 with the ability to control and monitor the progress of the job.

In operation of the JAVA virtual machine 34, the dialog interpreter 342 sends requests and pieces of script to the dialog manager 340. Each request may represent or cause a dialog state change and consists of: a prompt; a recognition grammar; details of the device events to wait for; and details of the job events to monitor. Of course, dependent upon the particular request, the events and jobs to monitor may have a null value, indicating that no device events are to be waited for or no jobs events are be monitored.

The operation of the system 1 will now be described with reference to the use of a single client 3 comprising a multi-functional device capable of facsimile, copying and printing operations.

FIG. 4 shows a flow chart illustrating the main steps carried out by the multi-function machine to carry out a job in accordance with a user's verbal instructions.

Initially, a voice-control session must be established at step S5. In this embodiment, this is initiated by the user activating a “voice-control” button or switch of the user interface 32 of the processor-controlled machine 3a. In response to activation of the voice control switch, the device operating system module 30 communicates with the JAVA virtual machine 34 via the device interface 341 to cause the dialog manager 340 to instruct the client module 343 to seek, via the server module 345, a slot on the speech processing apparatus or server 2. When the server 2 responds to the request and allocates a slot, then the session connection is established.

Once the session connection has been established, then the dialog interpreter 342 sends an appropriate request and any relevant pieces of script to the dialog manager 340. In this case, the request will include a prompt for causing the device operating system module 30 of the processor-controlled machine 3a to display on the user interface 32 a welcome message such as: “Welcome to this multifunction machine. What would you like to do?” The dialog manager 340 also causes the client and server modules 343 and 345 to send to the speech processing apparatus 2 over the network N the recognition grammar information in the request from the dialog interpreter so as to enable the appropriate grammar or grammars to be loaded by the ASR engine 201 (Step S6).

Step S6 is shown in more detail in FIG. 5. Thus, at step S60, when the user activates the voice control switch on the user interface 32, the client module 343 requests, via the server module 345 and the network N, a slot on the server 2. The client module 343 then waits at step S61 for a response from the server indicating whether or not there is a free slot. If the answer at step S61 is no, then the client module 343 may simply wait and repeat the request. If the client module 343 determines after a predetermined period of time that the server is still busy, then the client module 343 may cause the dialog manager 340 to instruct the device operating system module 30 (via the device interface), to display to the user on the user interface 32 a message along the lines of: “please wait while communication with the server is established”.

When the server 2 has allocated a slot to the device 3, then the dialog manager 340 and client module 343 cause, via the server module 345, instructions to be transmitted to the server 2 identifying the initial grammar file or files required for the ASR engine 201 to perform speech recognition on the subsequent audio data (step S62) and then (step S63) to cause the user interface 32 to display the welcome message.

Returning to FIG. 4, at step S7 spoken instructions received as audio data by the audio device 5 are processed by the audio module 344 and supplied to the client module 343 which transmits the audio data, via the server module 345, to the speech processing apparatus or server 2 over the network N in blocks or bursts at a rate of, typically, 16 or second bursts per second. In this embodiment, the audio data is supplied as raw 16 bit 8 kHz format audio data.

The JAVA virtual machine 34 receives data/instructions from the server 2 via the network N at step S8. These instructions are transmitted via the client module 343 to the dialog manager 340. The dialog manager 340 accesses the dialog interpreter 342 which uses the dialog file stored in the dialog store 343 to interpret the instructions received from the speech processing apparatus 2.

The dialog manager 340 determines from the result of the interpretation whether the data/instructions received are sufficient to enable a job to be carried out by the device (step S9). Whether or not the dialog manager 340 determines that the instructions are complete will depend upon the functions available on the processor-controlled machine 3a and the default settings, if any, determined by the dialog file. For example, the arrangement may be such that the dialog manager 340 understands the instruction “copy” to mean only a single copy is required and will not request further information from the user. Alternatively, the dialog file may require further information from the user when he simply instructs the machine to “copy”.

When the dialog manager 340 determines that further information is required from the user then further processing is performed at step S10 and steps S9 and S10 are repeated until the answer at step S9 is YES.

FIG. 6 shows in greater detail the step S10 of FIG. 4. Thus, at step S101, a new dialog state is entered in response to the interpretation by the dialog interpreter of the machine interpretable instructions. Thus, for example, where the original spoken instruction was the instruction “copy” and the multifunction machines requires further information (such as the number of copies, size and darkness of copies), then the JAVA virtual machine will enter a dialog state awaiting commands relating to those features. Thus for example, the JAVA virtual machine 34 may cause a prompt along the lines of “how many copies do you require?” to be displayed in the user interface 32. When, at step S102, further speech data is received from the user via the audio device 5, the client module 343 will transmit that speech data to the server 2 together with instructions identifying the speech recognition grammar to be used for that particular dialog state.

It is, of course, possible, particularly where a user is unfamiliar with a particular multifunction machine, that the user will ask the machine to perform functions that are not available on that machine, for example the user may ask for an A3 copy where the particular machine is only capable of producing A4 copies. Where the grammar or grammars associated with the particular multifunctional machine do not include words or rules for enabling identification of functions not available on that machine, then the speech processing apparatus will simply return machine interpretable instructions that enable the dialog manager 340 to cause the user interface 32 to display a method such as, for example: “command not recognised”. This, however, is not particularly helpful to a user. Accordingly, in a preferred arrangement, the grammar or grammars associated with the multi-function machine may include the rules or words necessary for identifying functions that may be carried out by machines of the same type but are not available on this particular machine. In this case, if the dialog manager 340 determines from the information in the device interface 341 that these features cannot be set on this particular machine then a prompt will be displayed to the user at step S10 saying, for example: “This machine cannot produce A3 copies”. The dialog manager may then wait for further instructions from the user. As an alternative to simply advising the user that the machine is incapable of providing the function required, the dialog manager 340 may, when it determines that the machine cannot carry out a requested function, access the JINI look-up service 4 over the network N via the look-up service module 346 to determine whether there are any machines coupled to the network N that are capable of providing the required function and, if so, will cause the device operating system module 30 to display a message to the user on the display of the user interface 32 at step S10 saying, for example: “This machine cannot produce double-sided copies. However, the photocopier on the first floor can”. The machine would then return to step S7 awaiting further instructions from the user.

When the data/instructions received at step S9 are sufficient to enable the job to be carried out, then at step S11 the dialog manager 340 registers a job listener to detect communications from the device operating system module 30 related to the job to be carried out, and communicates with the device operating system module 30 to instruct the processor-controlled machine to carry out the job.

If at step S12 the job listener detects an event, then the dialog manager 340 converts this to, in this example, a Voice XML event and passes it to the dialog interpreter 342 which, in response, instructs the dialog manager 340 causes a message to be displayed to the user at step S13 related to that event. For example, if the job listener determines that the multi-function device has run out of paper or toner or a fault has occurred in the copying process (for example, a paper jam or like fault) then the dialog manager 340 will cause a message to be displayed to the user at step S13 advising them of the problem. At this stage a dialog state may be entered that enables a user to request context-sensitive help with respect to the problem. When the dialog manager 340 determines from the job listener that the problem has been resolved at step S14, then the job may be continued. Of course, if the dialog manager 340 determines that the problem has not been resolved at step S14, then the dialog manager 340 may cause the message to continue to be displayed to the user or may cause other messages to be displayed prompting the user to call the engineer (step S15).

Assuming that any problem is resolved, then the dialog manager 340 then waits at step S16 for an indication from the job listener that the job has been completed. When the job has been completed, then the dialog manager 340 may cause the user interface 32 to display to the user a “job complete” message at step 16a. The dialog manager 340 then communicates with the speech processing apparatus 2 to cause the session to be terminated at steps S16b, thereby freeing the slot on the speech processing apparatus for another processor-controlled machine.

It will, of course, be appreciated that, dependent upon the particular instructions received and the dialog file, the dialog state may or may not change each time the further processing step S10 is repeated for a particular job and that, moreover, different grammar files may be associated with different dialog states. Where a different dialog state requires a different grammar file then, of course, the dialog manager 340 will cause the client module 343 to send data identifying the new grammar file to the speech processing apparatus 2 in accordance with the request from the dialog interpreter 342 so that the ASR engine 201 uses the correct grammar files for subsequent audio data.

FIG. 7 shows a flow chart for illustrating the main steps carried out by the server 2 assuming that the connection manager 204 has already received a request for a slot from the control apparatus 34 and has granted the control apparatus a slot.

At step S17 the connection manager 204 receives from the control apparatus 34 instructions identifying the required grammar file or files. At step S18, the connection manager 204 causes the identified grammar or grammars to be loaded into the ASR engine 201 from the grammar module 202. As audio data is received from the control apparatus 34 at step S19, the connection manager 204 causes the required grammar rules to be activated and passes the received audio data to the ASR engine 201 at step S20. At step S21, the connection manager 204 receives the result of the recognition process (the “recognition result”) from the ASR engine 201 and passes it to the speech interpreter module 203 which interprets the recognition result to provide an utterance meaning that can be interpreted by the dialog interpreter 342 of the device 3. When the connection manager 204 receives the utterance meaning from the speech interpreter module 203, it communicates with the server module 345 over the network N and transmits the utterance meaning to the control apparatus 34. The connection manager 204 then waits at step S24 for further communications from the server module 345 of the control apparatus 34. If a communication is received indicating that the job has been completed, then the session is terminated and the connection manager 204 releases the slot for use by another device or job. Otherwise steps S17 to S24 are repeated.

It will be appreciated that during a session the ASR engine 201 and speech interpreter module 203 function continuously with the ASR engine 201 recognising received audio data as and when it is received.

The connection manager 204 may be arranged to retrieve the grammars that may be required by a control apparatus connected to a particular processor-controlled machine and store them in the grammar module 202 upon first connection to the network. Information identifying the location of the grammar(s) may be provided in the device interface 341 and supplied to the connection manager 204 by the dialog manager 340 when the processor-controlled machine is initially connected to the network by the control apparatus 34.

It would be possible to provide each individual processor-controlled machine 3a with its own unique grammar or set of grammars that includes the rules for every possible function that a user may request via that particular machine. However, providing independent different grammars for each processor-controlled machine may result in duplication of rules between grammars. Thus, for example, providing one multi-function machine capable of photocopying and facsimile functions with its own unique grammar will inevitably result in duplication of rules between that grammar and the grammar for another different multi-function machine capable of the same or similar functions or, indeed, a photocopier capable of carrying out the same photocopy functions, for example.

In order to address this problem, the grammars stored in the grammar module 202 are configured so as to enable linking of two or more grammars by an interface grammar in accordance with linking instructions received from the dialog manager 340 in accordance with the dialog state.

FIG. 8 shows a very simplified functional block diagram of a grammar store 202a within the grammar module 202 to illustrate the linking of grammars. Thus, FIG. 8 shows grammars A and B that can be linked by an interface grammar I. The grammar A is configured to use grammar rules defined by the interface grammar I while the grammar B is configured to implement rules defined by the interface grammar I. Normally, the grammars A and B are independent. However, these grammars will be linked together by the interface grammar I by instructions provided by the JAVA virtual machine 34 when the dialog state indicates that linking of the grammars is required. This enables, in the case of a multifunction machine, for example, the grammar A to define grammar rules generic to a multiplicity of multi-function machines and grammar B to implement rules related to functions specific to that particular multi-function machine so that, for example, the grammar A can include grammar rules relating to commands such as “copy”, “fax”, “print” while grammar B can implement rules relating to, for example, copying options such as single-sided, double-sided etc., paper size such as A4, A3 etc and copy darkness, for example.

In the grammar store 202a shown functionally in FIG. 8, a single grammar A is linked via an interface grammar I to a grammar B. The grammar store 202a may, however, include a plurality of grammars A each linkable to a corresponding grammar B via an interface grammar I.

More than one grammar A may import interface I while more than one grammar B may implement rules defined by the interface I. The particular grammars A and B to be linked will be defined by the instructions related to the particular dialog state.

In addition, a plurality of different interfaces I may be provided so as to enable connection of grammars in a cascade. Thus, grammar B may, in addition to implementing rules B defined by the interface I, use rules implemented by a grammar C and defined by an interface J (not shown in FIG. 8). Also a first a grammar may be configured to import different interface grammars each of which defines rules implementable by a different second grammar or different set of second grammars.

The linking of grammars by an interface grammar also has the advantage that the developer or designer of a grammar need know nothing about any other grammars. All that the developer or designer of a grammar needs to know about is the characteristics and requirements of the interface grammar. Moreover, as set out above, a particular grammar A may be linked by the same interface grammar A to different grammars B dependant upon the circumstances. Thus, for example, a generic facsimile grammar A may be linked by the interface grammar I to a first specific facsimile grammar B by the dialog file for one specific type of facsimile machine and to a different specific facsimile grammar B by the dialog file for another specific facsimile machine. Also, a multifunction grammar A may be linked by the interface I to a copy grammar B when the function required of the multifunction machine is copying process and to a facsimile grammar B when the function required is a facsimile function.

This enables flexibility in the generation of the grammars and should allow, for example, standardisation of generic grammars which can be linked via an appropriate interface grammar or grammars to grammars specific to specific processor-controlled machines.

Another example which illustrates this is the case where the processor-controlled machine is facsimile machine. In this case, grammar A may be a grammar generic to all facsimile machines while grammar B may include functionalities specific to that type of facsimile machine, for example, the ability to delay transmission to a predetermined time. In this case the interface grammar I would define rules relating to spoken commands concerning time and date and these would be implemented by time and date grammar B.

As will be appreciated from the above, linking between grammars is a dynamic process and whether or not linking occurs depends upon the particular dialog state.

In contrast, although conventional systems may allow a first grammar to import a second grammar, the first grammar needs to identify the specific second grammar to be imported and accordingly in a conventional system a specific grammar A can only ever be linked with a specific grammar B. Thus, for example, in a conventional system a specific digital camera grammar may be designed to import a specific printer grammar which would enable printing of images from that camera only by the printer associated with the specific printer grammar and not by printers associated with different printer grammars.

FIG. 9 shows a functional block diagram similar to FIG. 3 for the case where the processor-controlled machine 3 is a digital camera. As can be seen from a comparison of FIGS. 3 and 9, the digital camera 3a shown in FIG. 9 has the same general functional components as the generic processor-controlled machine 3a shown in FIG. 3 except that, of course, the device operating system module is of course a specifically adapted camera operating system module 30 and the machine control circuitry is digital camera control circuitry 31. The JAVA virtual machine 34 has the same general functional components as set out in FIG. 3. In this case the device interface 341 comprises a camera object.

In addition to the components shown in FIG. 3, the JAVA virtual machine for the digital camera includes a printer service 347 and a printer chooser service 348. The printer service 347 and printer chooser service 348 may be downloaded by the JAVA virtual machine 34 from the network using the JINI look-up service 4 when the JAVA virtual machine 34 first couples the camera 3a to the network. The printer chooser service 348 uses the local JINI registrars in the look-up service module 346 to determine from the JINI look-up service 4 coupled to the network the available printers and information relating to the name by which these printers are identified. Once the printer chooser service 347 has identified the available printers, then the dialog manager 340 can conduct a dialog with the user via the user interface 32. Thus, the dialog manager 340 will cause instructions to be sent to the speech processing apparatus to access a printer chooser grammar that includes rules relating to printer choice and will then cause the user interface 32 to display to the user a message identifying the available printers and prompting a selection by the user. When a response is received from the user, the dialog manager 340 will cause the client module 343 and server module 345 to send the received speech data to the speech processing apparatus 2 over the network N for processing using the printer chooser grammar.

When the speech processing apparatus 2 returns the dialog interpretable instructions identifying the user's printer choice, the dialog manage 340 causes a JINI service object associated with the selected printer to be downloaded to form a printer service object 347 in the JAVA virtual machine 34 of the digital camera. This printer service object acts to emulate the functionality of the printer so that the digital camera JAVA virtual machine 34 can conduct a dialog with the user to obtain all information necessary to enable printing as required by the user without having to communicate with the printer until the printer service object 347 determines that all the information necessary for carrying out the job has been obtained. The printer service object 347 also enables communication with the selected printer during the carrying out of a printing operation so that the dialog manager 340 can advise the user of any events specific to the printer such as, for example, the lack of printing paper or a paper jam as described above with reference to FIG. 7.

The digital camera and selected printer are associated with their own respective grammar or grammars. However, as explained above with reference to FIG. 8, the grammars in the grammar store 202a are configured so that a camera grammar can be linked with a printer grammar via an interface grammar I in accordance with linking instructions provided by the dialog manager 340 when the dialog is in an appropriate dialog state. This means that the camera grammar and dialog need know nothing about the available printers and their grammars and dialogs and also that the printer grammars need have no information about the digital cameras that may be coupled to the network.

The information necessary for the dialog manager 340 to instruct linking of the camera grammar with the printer grammar specific to the selected printer will be determined from the information provided by the printer service object 348.

The following illustrates in broad outline how grammar A, in this case a printer grammar called “printergrammar”, may be linked to grammar B, in this case a camera grammar called “photograph_grammar”, via an interface grammar I called “document_grammar”.

In this case, the printer grammar “printergrammar” has the following general format:

grammar printergrammar:

import<document_grammar.*>;

public <Printoption>=(<printoption>|<documentoption>)+;

private <printoption>=A3|A4|high resolution | . . . ;

while the interface grammar “document_grammar” has the general format:

grammarinterface document_grammar;

public <documentoption>;

and the camera grammar called “photograph_grammar” has, in broad outline, the following format:

photograph_grammar implements document_grammar;

<documentoption>=panorama format| . . . ;

It will be seen from the above that the printer grammar “printer_grammar” imports the interface grammar named “document_grammar” while the interface grammar “document_grammar” defines a public grammar rule “documentoption” and the photograph grammar “photograph_grammar” implements that grammar rule.

In this case, in order to link the grammars “printergrammar” and “photograph_grammar” via the “document_grammar” interface grammar, the dialog file will contain, for the appropriate dialog states, a command along the following lines:

dialog file

<inputgrammar=“printergrammar printoptionlink:

document_grammar=photograph_grammar”>

It will, of course, be appreciated that the above-mentioned dialog file command will occupy a single line in the relevant dialog file and is only split into two lines for convenience. It will also be appreciated that there is no significance in the different format of the grammar names and that, for example, “printer grammar” could be “printer_grammar” for example.

In the example grammars and dialog file given above the ellipsis indicate the possibility of further rules in the grammar.

It will, of course, be appreciated that the specific rules and methods given above are only examples and that there may be many more or different rules and methods with the only requirements being that the interface grammar defines rules implementable by one grammar, the other grammar uses the grammar rules defined in the interface grammar and the dialog files provide, in the appropriate dialog states, instructions for the speech processing apparatus to link the two grammars using the interface grammar to form an extended, in the above example, “camera plus printer” grammar.

It will be appreciated by the person skilled in the art that the general grammar and dialog format described above may be applied to any grammars A and B to be linked together by an interface grammar I.

The embodiment described above with reference to FIG. 9 can, of course, be applied to any circumstance where one processor-controlled machine makes use of an independently supplied service, e.g. a printing service in the case of the digital camera. Thus, for example, the service may be an address book accessible by a facsimile machine or multi-function machine capable of facsimile operation for providing facsimile addresses or accessible by a computer or telephone having e-mail capability for providing e-mail addresses.

In the above described embodiment, each processor-controlled machine 3a is directly coupled to its own control apparatus 34 which communicates with the speech processing apparatus 2 over the network N.

In the above described embodiment, a dialog is conducted with a user by displaying messages to the user. It may however be possible to include on a client a speech synthesis unit controllable by the JAVA virtual machine to enable a fully spoken or oral dialog. This may be particularly advantageous where the processor-controlled machine has only a small display.

Where such a fully spoken or oral dialog is to be conducted, then requests from the dialog interpreter 342 will include a “barge-in flag” to enable a user to interrupt spoken dialog from the control apparatus when the user is sufficiently familiar with the functionality of the machine to be controlled that he knows exactly the voice commands to issue to enable correct functioning of that machine. Where a speech synthesis unit is provided, then in the system shown in FIGS. 10 and 11 the dialog with the user may be conducted via the user's telephone 5 rather than via a user interface of either the control apparatus 34 or the user interface of the processor-controlled machine and, in the system shown in FIG. 13 by providing the audio device 5 with an audio output as well as audio input facility.

It will be appreciated that the system shown in FIG. 1 may be modified to enable a user to use his or her DECT telephone to issue instructions with the communication between the audio device 5 and the audio module 343 being via the DECT telephone exchange. The DECT telephone will not, of course, be associated with a particular machine. It is therefore necessary for the control apparatus 34 to identify in some way the processor-controlled machine 3a to which the user is directing his or her voice control instructions. This may be achieved by, for example, determining the location of the mobile telephone from communication between the mobile telephone and the DECT exchange. As another possibility, each of the processor-controlled machines 3a coupled to the network may be given an identification and users instructed to initiate voice control by uttering a phrase such as “I am at copier number 9” or “this is copier number 9”. When this initial phrase is recognised by the ASR engine 201, the speech interpreter module 203 will provide to the control apparatus 34 via the connection manager 204 dialog interpretable instructions which identify to the control apparatus 34 the network address of, in this case, “copier 9”.

Where a speech synthesis unit is provided then the dialog with the user may be completely oral.

FIG. 10 shows another example of a system 1a embodying the invention. This system is specifically adapted to enable a fully oral communication or dialog with a user. In the system 1a, the clients 3′ are not provided with audio devices 5. Rather, the speech processing apparatus 2a is coupled to a communications device 2b which, in the simplest case, may consist of a microphone and loudspeaker combination or may consist of a telecommunications interface providing for connection to a telephone via, for example, a DECT telephone communication system installed in the building containing the speech processing apparatus or via a conventional land line or mobile telecommunication system.

As shown in FIG. 11, the speech processing apparatus 2a of the system 1a differs from that shown in FIG. 2 in that the speech processing apparatus incorporates an audio module 205 for receiving and processing audio data received from the communications device 2b in a similar manner to the audio module 344 shown in FIG. 3 and also a speech synthesizer 206, which under the control of the connection manager 204a, synthesizes spoken dialog to enable oral communication with the user via the communications device 2b.

The client 3′ shown in FIG. 12 differs from that shown in FIG. 3 in that the audio device 5 and audio module 344 are omitted.

The speech processing apparatus 2a shown in FIG. 11 is programmed so that, upon initial receipt of spoken commands via the communications device 2b, the ASR engine 201 uses a connection grammar from the grammar module 2 to recognise speech in the received audio data.

As an example, the clients 3′ may constitute processor-controlled machines comprising items of home equipment such as video recorders, televisions, microwaves and processor-controlled heating and lighting systems that may be coupled to the speech processing apparatus 2a via a network N.

In operation of such a system, a user may issue instructions via the communications device 2b to the speech processing apparatus 2a to, for example:

“connect me to the VCR”.

Once this command has been recognised by the ASR engine 201, the meaning is extracted by the speech interpreter module 203 and the connection manager 204 sends over the network N a dialog interpretable instruction or command to the VCR that the dialog manager 340 of the VCR JAVA virtual machine 34 interprets as a command activating voice control. The dialog interpreter 342 then causes the dialog manager 340 to send to the speech processing apparatus 2a via the client and server modules 343 and 345 instructions for the connection manager 204 to cause the connection grammar to be linked with a VCR grammar in the manner described above. The VCR grammar may be pre-stored in the grammar module 202 or may be stored by the dialog manager 340 of the virtual machine 34 and downloaded to the speech processing apparatus 2a when requested.

When the JAVA virtual machine 34 receives acknowledgement from the connection manager 204a that the grammar linking has been effected, then the dialog interpreter 342 enters a dialog state awaiting VCR command instructions and sends to the speech processing apparatus commands for causing the connection manager 204a to cause the speech synthesizer 206 to synthesize a prompt to the user saying something along the lines of: “Connection to VCR established”. Please input your instruction”. The user may then use voice control commands to control operation of the VCR in a manner similar to that described above with reference to FIGS. 1 to 9 with the exception that the dialog between the user and the JAVA virtual machine 34 is conducted by the JAVA virtual machine 34 causing the speech processing apparatus 2a to supply audio prompts to the user rather than by displaying such prompts on a user interface of the VCR.

Because the JAVA virtual machine 34 causes the VCR grammar to be linked with the connection grammar, when the user wishes to control another processor-controlled machine, for example a processor controlling a heating or lighting system, then the user need simply issue the command “connect me to the lighting system” and the ASR engine 201 will be able to recognise this message because the connection grammar is still loaded. Thus, it is not necessary for the user to terminate the voice control of the VCR and then request re-connection to the connection grammar to enable another client to be subject to voice control.

It will be appreciated that the system shown in FIG. 10 may be adapted so that the communications device 2b displays visual (or visual and audio) prompts to the user, for example in the case where the user is issuing voice control commands directly at the communications device 2b or the user has a video phone. Where visual prompts are possible then, of course, the speech synthesizer 206 may be omitted and the communications device need only be capable of receiving audio data.

The communications device 2b may be incorporated in the speech processing apparatus 2a and the speech processing apparatus 2a may be portable. In this case, the link between the speech processing apparatus and a client need not necessarily be over a fixed network but may be a one-to-one remote link, for example an infra red or wireless remote link.

In the above described example, the grammar specific to an individual client may be downloaded from the client as and when required by the speech processing apparatus so that the grammar module 202 does not need to store all possible grammars. This would have advantage even where the JAVA virtual machines are not capable of linking grammars although in those cases it would be necessary for the user always to return to the connection grammars between voice control of different clients.

In the above described embodiments, grammars can be linked in accordance with the dialog state of the JAVA virtual machine so that the extent of grammar available to the automatic speech recognition engine is controlled in accordance with the dialog state of the JAVA virtual machine. This dynamic linking of grammars enables, for example, standard generic grammars to be provided, for example, generic print, copy and fax grammars containing the rules common to all types of printer, copier and facsimile machines), and for these to be linked dynamically, as and when necessary, to further grammars specific to the particular printer, copier or facsimile machine. Also, the ability to link grammars enables a function of one machine coupled to the network to be controlled by spoken demands directed to another machine coupled to the network (for example, a printer and digital camera) without either of the two machines having to have any information about the functionality of the other machine.

Although the present invention has particular applications and advantages to network systems, it will be appreciated that the present invention may be used in circumstances where a speech processing apparatus communicates remotely with one or more stand alone devices incorporating control apparatus as described above via, for example, a remote link such as an infra red or radio link.

In the above described embodiments, the virtual machines 34 are JAVA virtual machines. There are several advantages to using JAVA. Thus, the platform independence of JAVA means that the client code is reusable on all JAVA virtual machines and, as mentioned above, use of JAVA enables use of the JINI framework and a JINI look-up service on the network.

It will be appreciated by those skilled in the art that it is not necessary to use the JAVA platform and that other platforms that provide similar functionality may be used.

As used herein the term “processor-controlled machine” includes any processor-controlled device, system or service that can be coupled to the control apparatus to enable voice control of a function of that device, system or service.

Other modifications will be apparent to those skilled in the art.

1. A system comprising:
at least one device having a processor-controlled machine for causing at least one function specified by a user to be carried out and a control apparatus for enabling voice-control of the processor-controlled machine and a speech processing apparatus having means for receiving speech data representing speech by a user, a grammar store storing speech recognition grammars, speech recognition means for recognising speech in the received speech data using at least one of the speech recognition grammars, speech interpreting means for interpreting the recognised speech to provide instructions for controlling at least one function of a processor-controlled machine and transmitting means for transmitting the instructions to the control apparatus,
the control apparatus being arranged to couple the processor-controlled machine to the speech processing apparatus and having means for providing speech recognition grammar instructions regarding the speech recognition grammar to be used by the speech recognition means for recognising speech data and means for transmitting speech recognition grammar instructions to the speech processing apparatus, wherein the grammar store comprises at least first and second grammars having grammar rules and at least one interface grammar defining grammar rules, the first grammar being arranged to use grammar rules defined by the interface grammar and the second grammar being arranged to implement rules defined by the interface grammar, and wherein the speech recognition grammar instructions providing means is arranged to provide instructions for causing the second grammar to be linked to the first grammar using the interface grammar.

2. A system according to claim 1, wherein the control apparatus comprises a JAVA virtual machine.

3. A system according to claim 1, wherein the processor-controlled machine of said at least one device is arranged to carried out said at least one function.

4. A system according to claim 3, wherein the processor-controlled machine is selected from the group consisting of:
a photocopier, a facsimile machine, a multi-function machine, a television, a video cassette recorder, a microwave oven, a heating system, a lighting system.

5. A system according to claim 1, wherein the processor-controlled machine of said at least one device is arranged to cause another device coupled to the network to carry out the at least one function.

6. A system according to claim 5, comprising as said other device a device comprising a processor-controlled machine and a control apparatus.

7. A system according to claim 5, wherein the at least one device comprises a digital camera and said other device comprises a printer.

8. A system according to claim 7! wherein the first grammar comprises a camera grammar and the second grammar comprises a printer grammar.

9. A system according to claim 1, wherein the control apparatus comprises receiving means for receiving instructions derived from speech recognised by the speech recognition means;
dialog communication means for communicating with the user to provide information to the user in response to instructions received by said receiving means thereby enabling a dialog with the user, wherein the dialog communication means has a number of different dialog states and is arranged to change dialog states in response to instructions receiving by the receiving means, the control apparatus being arranged to supply to the speech processing apparatus instructions regarding the speech recognition grammar or grammars to be used in dependence upon the dialog state of the dialog communication means such that, in at least one dialog state, the control apparatus is arranged to provide instructions to cause said first and second grammars to be linked by said interface grammar.

10. A system according to claim 1, wherein the control apparatus is arranged to couple the processor-controlled machine to the speech processing apparatus via a network.

11. A speech processing apparatus for receiving speech data representing commands spoken by a user for controlling a function of a device, the speech processing apparatus having:
receiving means for receiving speech data representing speech by a user;
a grammar store storing speech recognition grammars;
speech recognition means for recognising speech in the received speech data using at least one of the speech recognition grammars;
speech interpreting means for interpreting recognised speech to provide instructions for enabling a function of a device to be controlled; and
transmitting means for transmitting the instructions to a device for enabling control of a function of that device, wherein the grammar store comprises at least first and second grammars having grammar rules and at least one interface grammar defining grammar rules, the first grammar being arranged to use grammar rules defined by the interface grammar and the second grammar being arranged to implement rules defined by the interface grammar such that the second grammar can be linked to the first grammar using the interface grammar to form an extended grammar.

12. A speech processing apparatus according to claim 11, wherein the first and second grammars comprises camera and printer grammars, respectively.

13. A control apparatus for coupling a processor-controlled machine to speech processing apparatus for enabling a user to control a function of a machine by spoken commands, the control apparatus having: means for providing speech recognition grammar instructions defining a speech recognition grammar or grammars to be used by the speech processing apparatus means for recognising speech data; and means for transmitting to the speech processing apparatus the speech recognition grammar instructions for speech data representing words spoken by a user, the speech recognition grammar instructions providing means being arranged to provide instructions for causing first and second grammars to be linked by an interface grammar having grammar rules usable by the first grammar and implementable by the second grammar so as to form an extended grammar.

14. A control apparatus for enabling coupling of a processor-controlled machine to speech processing apparatus for enabling a user to control a function of the processor-controlled machine by spoken commands, the control apparatus comprising:
receiving means for receiving from the speech processing apparatus instructions derived from speech recognised by the speech processing apparatus;
dialog communication means for communicating with the user to provide information to the user in response to instructions received from the speech processing apparatus thereby enabling a dialog with the user, wherein the dialog communication means has a number of different dialog states and is arranged to change dialog state in response to received instructions, the control apparatus being arranged to supply to the speech processing apparatus instructions regarding the speech recognition grammar or grammars to be used in dependence upon the dialog state of the dialog communication means such that, in at least one dialog state, the control apparatus is arranged to provide instructions to cause first and second grammars to be linked by an interface grammar having grammar rules usable by the first grammar and implementable by the second grammar so as to form an extended grammar.

15. A control apparatus according to claim 13, wherein the control apparatus comprises a JAVA virtual machine.

16. A device couplable to a network, the device comprising a control apparatus in accordance with the claim 13 and a processor-controlled machine.

17. A device according to claim 16, wherein the processor-controlled machine is arranged to carry out at least one function.

18. A device according to claim 17, wherein the processor-controlled machine is selected from the group consisting of:
a photocopier, a facsimile machine, a multi-function machine, a television, a video cassette recorder, a microwave oven, a heating system, a lighting system.

19. A device according to claim 16, wherein the processor-controlled machine is arranged to cause another device coupled to the network to carry out the at least one function.

20. An assembly comprising a device in accordance with claim 19 and, as said other device, a device comprising a processor controlled machine and a control device.

21. An assembly according to claim 20, wherein the device comprises a digital camera and said other device comprises a printer.

22. A grammar store for use in a system in accordance with claim 1, the grammar store having at least one of the following:
a first grammar; an interface grammar defining grammar rules usable by the first grammar; and a second grammar configured to implement grammar rules defined by the interface grammar to enable the first and second grammars to be linked by the interface grammar to form an extended grammar.

23. A grammar store for use in a system in accordance with claim 7, the grammar store having at least one of the following:
a first grammar comprising one of a camera and a printer grammar;
a second grammar comprising the other of the camera and printer grammars; and
an interface grammar defining grammar rules usable by the first grammar, the second grammar being configured to implement grammar rules defined by the interface grammar to enable the first and second grammars to be linked by the interface grammar to form an extended grammar.

24. A computer program product comprising processor implementable instructions for configuring a processor to provide control apparatus of a system in accordance with claim 1.

25. A signal comprising a computer program product in accordance with claim 24.

26. A storage medium carrying a computer program product in accordance with claim 24.

27. In a system comprising:
at least one device having a processor-controlled machine for causing at least one function specified by a user to be carried out and a control apparatus for enabling voice-control of the processor-controlled machine and a speech processing apparatus having means for receiving speech data representing speech by a user, a grammar store storing speech recognition grammars, speech recognition means for recognising speech in the received speech data using at least one of the speech recognition grammars, speech interpreting means for interpreting the recognised speech to provide instructions for controlling at least one function of a processor-controlled machine and transmitting means for transmitting the instructions to the control apparatus, a method of operating the control apparatus which comprises:
providing speech recognition grammar instructions regarding the speech recognition grammar to be used by the speech recognition means for recognising speech data to the speech processing apparatus to cause a first grammar using grammar rules defined by an interface grammar to be linked by the interface grammar to a second grammar which implements rules defined by the interface grammar to form an extended grammar.

28. A method according to claim 27, which comprises:
receiving instructions derived from speech recognised by the speech recognition means;
communicating with the user to provide information to the user in response to received instructions enabling a dialog with the user with the dialog having a dialog state dependent on the received instructions; and supplying to the speech processing apparatus instructions regarding the speech recognition grammar or grammars to be used in dependence upon the dialog state such that, in at least one dialog state, the instructions cause said first and second grammars to be linked by said interface grammar.

29. A method of operating a speech processing apparatus for receiving speech data representing commands spoken by a user for controlling a function of a device, the method comprising:
receiving speech data representing speech by a user;
accessing a grammar store comprising at least first and second grammars having grammar rules and at least one interface grammar defining grammar rules;
causing a first grammar which uses grammar rules defined by an interface grammar to be linked by the interface grammar to a second grammar which implements rules defined by the interface grammar;
recognising speech in the received speech data;
interpreting recognised speech to provide instructions for enabling a function of a device to be controlled; and
transmitting the instructions to a device for enabling control of a function of that device to form an extended grammar.

30. A method of operating a control apparatus for coupling a processor-controlled machine to speech processing apparatus for enabling a user to control a function of a machine by spoken commands, which method comprises transmitting speech recognition grammar instructions defining a speech recognition grammar or grammars to be used by the speech processing apparatus means for recognising speech data including instructions for causing first and second grammars to be linked by an interface grammar having grammar rules usable by the first grammar and implementable by the second grammar so as to form an extended grammar.

31. A method of operating a control apparatus for enabling coupling of a processor-controlled machine to speech processing apparatus remote from the processor-controlled machine for enabling a user to control a function of the processor-controlled machine by spoken commands, the method comprising:
receiving from the speech processing apparatus instructions derived from speech recognised by the speech processing apparatus;
communicating with the user to provide information to the user in response to instructions received from the speech processing apparatus using a dialog which has a number of different dialog states dependent upon the received instructions; and supplying to the speech processing apparatus instructions regarding the speech recognition grammar or grammars to be used in dependence upon the dialog state of the dialog communication means such that, in at least one dialog state, the instructions cause first and second grammars to be linked by an interface grammar having grammar rules usable by the first grammar and implementable by the second grammar so as to form an extended grammar.

32. A computer program product comprising processor implementable instructions for causing a processor to carry out a method in accordance with claim 27.

33. A signal or storage medium carrying a computer program product in accordance with claim 32.

34. A control apparatus for enabling a user to control a function of each of a plurality of processed-controlled machines by spoken commands interpreted by speech processing apparatus using speech recognition grammars, the control apparatus having a connection manager for determining from a command spoken by a user the machine that the user wishes to control and speech recognition grammar accessing means for accessing a grammar or grammars for the machine identified by the connecting manager to enable subsequent commands to be interpreted by the speech processing apparatus using the access grammar or grammars.

35. An apparatus according to claim 34, wherein the control apparatus is arranged to access the speech recognition grammar or grammars by downloading from the identified machine.

36. A control apparatus according to claim 34, incorporating speech processing apparatus for processing commands received by the control apparatus.

37. A control apparatus according to claim 34, wherein the connection manager is arranged to determine from commands spoken by a user when the user wishes to control another machine and to access the speech recognition grammar or grammars for that machine to enable subsequent commands to interpreted using the accessed grammar or grammars.

38. A system comprising:
a processor-controlled machine for causing at least one function specified by a user to be carried out; a control apparatus for enabling voice-control of the processor-controlled machine;
an audio input device for receiving speech from a user and for supplying speech data representing the received speech; and
a speech processing apparatus having means for receiving speech data from the audio input device, a grammar store storing speech recognition grammars, speech recognition means for recognising speech in the received speech data using at least one of the speech recognition grammars, speech interpreting means for interpreting the recognised speech to provide instructions for controlling at least one function of a processor-controlled machine and transmitting means for transmitting the instructions to the control apparatus,
the control apparatus being arranged to couple the processor-controlled machine to the speech processing apparatus and having means for providing speech recognition grammar instructions regarding the speech recognition grammar to be used by the speech recognition means for recognising speech data and means for transmitting speech recognition grammar instructions to the speech processing apparatus, wherein the grammar store comprises at least first and second grammars having grammar rules and at least one interface grammar defining grammar rules, the first grammar being arranged to use grammar rules defined by the interface grammar and the second grammar being arranged to implement rules defined by the interface grammar, and wherein the speech recognition grammar instructions providing means is arranged to provide instructions for causing the second grammar to be linked to the first grammar using the interface grammar.
